(19) United States
(12) Patent Application Publication
(10) Pub. No.: US 2017/0210942 A1
(43) Pub. Date: Jul. 27, 2017

(54) Anti-Abrasion Varnish Composition for a Substrate Made from Thermoplastic Polyacrylate

(71) Applicant: ESSILOR INTERNATIONAL (COMPAGNIE GENERALE D'OPTIQUE), Charenton-le-Pont (FR)

(72) Inventor: Yves LECLAIRE, Charenton-le-Pont (FR)

(21) Appl. No.: 15/329,481

(22) PCT Filed: Jul. 27, 2015
(86) PCT No.: PCT/FR2015/052066

§ 371 Date: Jan. 26, 2017

(30) Foreign Application Priority Data
Jul. 30, 2014 (FR) 14 57394

(51) Int. Cl. C09D 183/04; G02B 1/14; B29D 11/00; G02B 1/04; C09D 5/00; C08J 7/16

(52) U.S. Cl. CPC C09D 183/04; C09D 5/00; C08J 7/16; B29D 11/00865; G02B 1/041; G02B 1/14; C08J 2333/12; C08J 2483/04

(57) ABSTRACT

The present invention relates to a polymerizable composition for the formation of a lacquer on at least one face of an ophthalmic lens made from thermoplastic material from the polyacrylate family, comprising a curable organosilicon compound, and a condensation catalyst, said composition not containing any monomer having an epoxy or vinyl function or any compound originating from such monomers, so as to improve the adhesion of said lacquer to said lens.

The present invention relates to a polymerizable composition for the production of an abrasion-resistant lacquer for an ophthalmic lens made of thermoplastic material of the polyacrylate family, such as polymethyl methacrylate (PMMA). It also relates to a process for preparing this composition and also to a lacquer obtained from this composition, to an ophthalmic lens comprising said lacquer and to a process for manufacturing this ophthalmic lens.

Polyacrylates are thermoplastic materials used in ophthalmic applications such as the manufacture of eyeglasses. Due to their thermoplastic properties, they can be formed by inexpensive processes. Furthermore, the offcuts or rejects may be reused, which has advantages from the economic and environmental viewpoint.

However, organic substrates, in particular made of polyacrylates, generally have a much lower abrasion resistance than glass substrates. It is therefore customary to apply a coating to the surface of the organic substrates in order to improve the abrasion resistance thereof.

The abrasion-resistant lacquers conventionally used for polycarbonate substrates, or substrates made of polyurethane copolymer, do not adhere sufficiently to polyacrylate substrates. The adhesion of these lacquers to polyacrylate substrates has been able to be improved by the use of adhesion primers. However, the formation of a primer/abrasion-resistant lacquer bilayer is an expensive process. There therefore remains a need to have an abrasion-resistant lacquer that has good adhesion to polyacrylate substrates without requiring an adhesion primer.

Starting from this observation, the Applicant has developed a polymerizable composition comprising a curable organosilicon compounds that makes it possible to obtain an abrasion-resistant lacquer having good adhesion properties to polyacrylate substrates, even in the absence of an adhesion primer, and also a good hold over time and which, furthermore, has good abrasion-resistance properties similar to, or even better than, those of the lacquers currently used.

Thus, the present invention relates to a polymerizable composition for the production of lacquer on at least one face of an ophthalmic lens made of thermoplastic material of the polyacrylate family, comprising at least a curable organosilicon compound and a condensation catalyst, said composition being free of any monomer comprising a vinyl or epoxy function and of any compound derived from such monomers, in order to improve the adhesion of said lacquer to said lens.

Vinyl or epoxy monomers, such as y-glycidoxypropyltrimethoxysilane, are often used in ophthalmics to promote the adhesion of lacquer to the lens substrates, said substrates being, for example, made of polycarbonate or based on polythiourethanes or on polysulfides.

The inventors have however identified that, surprisingly, vinyl or epoxy monomers reduce the adhesion of the lacquers to substrates made of polyacrylate material, in particular made of polymethyl methacrylate.

The curable organosilicon compound according to the present invention is a compound resulting from a hydrolysis reaction, in the presence of a first acid, of at least two monomers of formula (1)

R′ₙSi(OR)₄₋ₙ (1)

wherein n is an integer between 0 and 3, each R′ is independently selected from (C1-C6)alkyl, aryl and aryl(C1-C6)alkyl, and each R is independently selected from (C1-C6)alkyl.

Furthermore, the first acid, used for the hydrolysis reaction, is a weak acid in an aqueous medium.

As a reminder, a weak acid in an aqueous medium is an acid that does not completely dissociate in water.

The inventors have identified that the use of a weak acid instead of a strong acid, in a composition without vinyl or epoxy monomers, made it possible to improve the adhesion to substrates made of polyacrylate material, in particular polymethyl methacrylate, and made it possible in particular to improve the shelf life of the composition. The shelf life of the composition is the duration for which the composition may be kept after having been manufactured without creating defects in the lacquer during the use thereof to form a lacquer on a lens.

According to one preferred embodiment of the invention, the polymerizable composition is intended for the production of a lacquer on at least one face of an ophthalmic lens, the substrate of which is a thermoplastic of the polyacrylate family.

Within the meaning of the present invention, the term “(C1-C6)alkyl” denotes any monovalent linear or branched group having from 1 to 6 carbon atoms. The (C1-C6)alkyls comprise in particular (C1-C4)alkyls such as methyl, ethyl, propyl, isopropyl, butyl, isobutyl and tert-butyl.

Within the meaning of the present invention, the term “aryl” denotes any monovalent aromatic group having from 6 to 18 carbon atoms, optionally substituted by 1 to 4 groups, which are identical or different independently of one another, selected from halogens, (C1-C6)alkyls, (C1-C6)alkyloxy. The aryls are in particular phenyl, tolyl or naphthyl.

Within the meaning of the present invention, the term “aryl(C1-C6)alkyl” denotes any (C1-C6)alkyl group as defined above substituted by an aryl group as defined above. The aryl(C1-C6)alkyls comprise in particular aryl(C1-C4)alkyls such as benzyl and phenylethyl.

In formula (1), each R′ is preferably independently selected from (C1-C4)alkyl, phenyl and phenyl(C1-C4)alkyl, more preferentially independently selected from (C1-C4)alkyl, more preferentially still independently selected from methyl and ethyl; and each R is preferably independently selected from (C1-C4)alkyl, more preferentially independently selected from methyl and ethyl.

The organosilicon compound is obtained by hydrolysis of at least two monomers of formula (1) as defined above. Preferably, said at least two monomers comprise a monomer (A) of formula (1) wherein n is an integer between 1 and 3, each R′ is independently selected from (C1-C6)alkyl, aryl, aryl(C1-C6)alkyl, and each R is independently selected from (C1-C6)alkyl; and a monomer (B) of formula (1) wherein n is 0 and each R is independently selected from (C1-C6)alkyl.

The monomer (A) is preferably a monomer of formula (1) wherein n is 1 or 2, and each R is independently selected from (C₁-C₄)alkyl, and each R′ is independently selected from (C1-C4)alkyl. In particular, the monomer (A) may be selected from methyltrimethoxy silane, methyltriethoxysilane and dimethyldiethoxysilane.

The monomer (B) is preferably a monomer of formula (1) wherein n is 0 and each R is independently selected from (C1-C4)alkyl. In particular, the monomer (B) may be selected from tetramethoxysilane and tetraethoxysilane.

In one particular embodiment, the organosilicon compound is obtained by hydrolysis of a monomer (A) selected from methyltriethoxysilane and methyltriethoxysilane, and tetraethoxysilane as monomer (B).

The composition according to the invention typically comprises from 80% to 98% by weight, preferably from 85% to 95% by weight, of organosilicon compound relative to the total dry weight of the composition. In case where said at least two monomers of formula (1) comprise a monomer (A) and a monomer (B), the proportion of monomer (A) typically represents from 50% to 90% by weight, preferably from 60% to 85% by weight, more preferentially from 70% to 80% by weight relative to the total dry weight of the composition, and the monomer (B) typically represents from 5% to 40% by weight, preferably from 8% to 30% by weight, more preferentially from 10% to 20% by weight relative to the total dry weight of the composition.

The molar ratio of the monomer (B) relative to the monomer (A) is preferably between 0.01 and 0.5, more preferentially between 0.1 and 0.3.

The hydrolysis is carried out in the presence of a first acid which is a weak acid in an aqueous medium. The first acid may be a carboxylic acid selected for example from acetic acid, propionic acid, butyric acid, acrylic acid and mixtures thereof. Preferably, the weak acid is acetic acid. The hydrolysis is preferably carried out at a pH between 4.0 and 4.5.

The composition according to the invention comprises a condensation catalyst selected in particular from imidazoles, amidines and cyclic or bicyclic amidines. Examples of condensation catalysts include N-methylimidazole, diazabicycloundecene and diazabicyclononene. Preferably, the condensation catalyst is 1,8-diazabicyclo[5.4.0]undec-7-ene (DBU).

The composition according to the invention typically comprises from 0.1% to 2% by weight, preferably from 0.3% to 1% by weight, of condensation catalyst relative to the dry weight of the composition.

The composition according to the invention optionally comprises a second acid, said acid preferably being a weak acid in an aqueous medium, and more preferentially a carboxylic acid, more preferentially still selected from acetic acid, propionic acid, butyric acid, acrylic acid and mixtures thereof, acetic acid being preferred. This second acid is added during the steps of preparing the composition after the first hydrolysis step, and it may be identical to or different from the first acid used during the first hydrolysis step. This second acid has a role of adjusting the pH of the polymerizable composition and may make it possible to stabilize the composition and therefore to lengthen the shelf life of said composition.

The composition according to the invention typically has a pH between 3.5 and 5, preferably between 4.0 and 4.7.

The composition according to the invention may also comprise additional additives such as organic solvents or surfactants, such as those customarily used by a person skilled in the art of abrasion-resistant lacquers for the ophthalmic field.

The composition according to the invention may also comprise colloids in order to increase the hardness and the abrasion resistance of the lacquer. These colloids are, for example, colloids of silica, of hollow silica, of zirconia or of titanium dioxide. Typically, the composition according to the invention may comprise at most 60% by weight of colloids relative to the dry weight of the composition.

The composition is free of monomer comprising an epoxy or vinyl function. Preferably, the composition does not comprise any silane monomer comprising a polymerizable function other than an alkyloxy function. More preferentially, the composition does not comprise any monomer comprising a polymerizable function other than an alkyloxy function. In one particular embodiment, the composition according to the invention comprises, as monomers, only monomers of formula (1) or hydrolyzates thereof.

The present invention also relates to a process for preparing a polymerizable composition for the production of lacquer on at least one face of an ophthalmic lens made of thermoplastic material of the polyacrylate family, preferably of polymethyl methacrylate (PMMA) as defined above.

This process comprises:

the hydrolysis, in the presence of a first acid, of at least two monomers of formula of formula (1)

R′ₙSi(OR)₄₋ₙ (1)

wherein n is an integer between 0 and 3, each R′ is independently selected from (C1-C6)alkyl, aryl, aryl(C1-C6)alkyl, and each R is independently selected from (C1-C6)alkyl;
in order to obtain a hydrolyzate comprising a curable organosilicon compound;

the addition of a condensation catalyst and optionally of a second acid to the hydrolyzate obtained in the hydrolysis step.

The hydrolysis is carried out using a mixture to be hydrolyzed comprising at least two monomers of formula (1) in the presence of the first acid and water. It results in a hydrolyzate comprising a curable organosilicon compound.

The first acid is a weak acid in an aqueous medium.

The hydrolysis is carried out in the presence of a first acid. The first acid may be a carboxylic acid selected for example from acetic acid, propionic acid, butyric acid, acrylic acid and mixtures thereof. Preferably, the first acid is acetic acid.

The monomers of formula (1) are preferably as defined above for the composition according to the invention. In case where said least two monomers of formula (1) comprise a monomer (A) and a monomer (B), the molar ratio of the monomer (B) relative to the monomer (A) is preferably between 0.01 and 0.5, more preferentially between 0.1 and 0.3. The mixture to be hydrolyzed typically comprises 40% to 80% by weight, preferably 50% to 70% by weight, more preferentially 55% to 65% by weight of monomer (A); 2% to 20% by weight, preferably 5% to 15% by weight, more preferentially 7% to 13% by weight of monomer (B); 1% to 9% by weight, preferably 3% to 7% by weight of the first weak acid; and 15% to 35% by weight, preferably 20% to 30% by weight of water.

In one preferred embodiment, the hydrolysis is carried out at a pH between 3.5 and 5.0, preferentially 4.0 to 4.7. The hydrolysis is typically carried out for 10 to 50 h, preferably for 20 to 30 h. The hydrolysis is generally carried out at ambient temperature. However, the hydrolysis reaction may increase the temperature of the reaction medium during the hydrolysis. The temperature is preferably kept below 50° C.

The hydrolysis does not involve any monomer comprising an epoxy or vinyl function. Preferably, the hydrolysis does not involve any silane monomer comprising a polymerizable function other than an alkyloxy function. Preferably, the hydrolysis does not involve any monomer comprising a polymerizable function other than an alkyloxy function. In one particular embodiment, the hydrolysis only involves monomers of formula (1).

At the end of the hydrolysis step, the condensation catalyst and optionally the second weak acid are added to the hydrolyzate obtained. The addition of the condensation catalyst and of the second weak acid, if present, may be carried out at the same time or separately. For example, the second weak acid is added after the condensation catalyst.

The condensation catalyst is preferably as defined above for the composition according to the invention. The condensation catalyst may be added in a proportion of from 0.1% to 2% by weight, preferably from 0.3% to 1% by weight relative to the total dry weight of the polymerizable composition.

The second acid is preferably a weak acid in an aqueous medium. It may be identical to or different from the first acid. Preferably, the first acid and the second acid are identical. The second acid may be a carboxylic acid selected for example from acetic acid, propionic acid, butyric acid, acrylic acid and mixtures thereof. Preferably, the second acid is acetic acid. The second acid is added in a sufficient amount for the polymerizable composition to have a pH between 4.0 and 4.7.

Other components such as a solvent, surfactants or colloids as defined above for the composition according to the invention may be added.

In the process according to the invention, no monomer comprising an epoxy or vinyl function is added to the hydrolyzate obtained at the end of the hydrolysis step. Preferably, no silane monomer comprising a polymerizable function other than an alkyloxy function is added to the hydrolyzate. Preferably, no monomer comprising a polymerizable function other than an alkyloxy function is added to the hydrolyzate. In one particular embodiment, the composition according to the invention comprises only monomers of formula (1).

The composition according to the invention makes it possible to obtain lacquers having a very good resistance, in particular an abrasion resistance greater than or equal to 1.8, preferably greater than or equal to 2. Furthermore, these lacquers have a good adhesion to the supports made of polyacrylates, in particular PMMA, even in the absence of an adhesion primer. The abrasion resistance is measured using the BAYER test carried out in accordance with the ASTM F735.81 standard. A high value in the BAYER test corresponds to a high degree of abrasion resistance.

Thus, the present invention also relates to a lacquer obtained from the polymerizable composition as defined above. More specifically, the lacquer is obtained by applying, by processes well known to a person skilled in the art such as for example by spin coating, or spray coating, or inkjet printing or else dip coating, a layer of the composition according to the invention on a substrate and thermally polymerizing said layer of composition, preferably at a temperature below the glass transition temperature of the substrate.

The present invention also relates to an ophthalmic lens comprising a substrate made of polyacrylate thermoplastic material, preferably made of PMMA, coated with the lacquer according to the invention as defined above. Such an ophthalmic lens may be manufactured by a process comprising the application of the polymerizable composition according to the invention to at least one face of a substrate made of polyacrylate thermoplastic material, preferably made of PMMA, and the thermal polymerization, preferably at a temperature below the glass transition temperature of said substrate of the layer of polymerizable composition thus obtained.

### EXAMPLES

### Example 1

The hydrolysis of 267.8 g of methyltriethoxysilane and 38.8 g of tetraethoxysilane in the presence of 20 g of acetic acid and 94.6 g of water is carried out over 24 h.

At the end of the hydrolysis, 2.2 g of DBU (diazabicycloundecene) are added to and mixed with the hydrolyzate obtained. Lastly, 15 g of acetic acid and 0.6 g of a surfactant (EFKA 3034 sold by Aldrich) are added to the composition in order to obtain a ready-to-use lacquer.

### Comparative Example 1

The hydrolysis of 487.4 g of methyltriethoxysilane and 142 g of tetraethoxysilane in the presence of 50 g of acetic acid and 248 g of water is carried out over 24 h. At the end of the first hydrolysis, 80 g of glycidyloxypropyltrimethoxysilane and 20 g of water are added to the hydrolyzate. A second hydrolysis is carried out over 3 to 4 days. At the end of the second hydrolysis, between 0.8% and 1.3% of DBU in order to obtain a ready-to-use lacquer.

Characterization of the Lacquers

A layer of composition according to example 1 or according to comparative example 1 is applied by dip-coating to a PMMA lens without adhesion primer. This coating is polymerized for 3 h at a temperature of 100° C.

The adhesion of the coating is measured according to the crosshatch adhesion test according to the ISTM 02-010 standard. This test defines an adhesion score from 0 to 5. A score of 0 or 1 is acceptable for ophthalmic lenses whereas the scores from 3 to 5 are not acceptable.

The abrasion resistance is measured according to the BAYER test in accordance with the ASTM F735.81 standard. The higher the value, the better the abrasion resistance.

The results are presented in table 1 below.

TABLE 1

| | | Comparative |
|---|---|---|
| | Example 1 | example 1 |
| Adhesion | 0 | 5 |
| Abrasion resistance | 2.0 | 1.6 |

1. -13. (canceled)

14. A polymerizable composition for the production of lacquer on at least one face of an ophthalmic lens made of thermoplastic material of the polyacrylate family, comprising:
a curable organosilicon compound; and
a condensation catalyst;
the composition being free of any monomer comprising a vinyl or epoxy function and of any compound derived from such monomers, in order to improve the adhesion of the lacquer to the lens;
wherein the curable organosilicon compound is a compound resulting from a hydrolysis reaction, in the presence of a first acid, of at least two monomers of formula of formula (1)
R′ₙSi(OR)₄₋ₙ (1)
wherein:
n is an integer between 0 and 3;
each R′ is independently selected from (C1-C6)alkyl, aryl, aryl(C1-C6)alkyl; and
each R is independently selected from (C1-C6)alkyl; and
wherein the first acid is a weak acid in an aqueous medium.

15. The composition of claim 14, wherein the at least two monomers comprise:
a monomer (A) of formula (1) wherein:
n is an integer between 1 and 3;
each R′ is independently selected from (C1-C6)alkyl, aryl, aryl(C1-C6)alkyl; and
each R is independently selected from (C1-C6)alkyl; and
a monomer (B) of formula (1) wherein:
n is 0; and
each R is independently selected from (C1-C6)alkyl.

16. The composition of claim 15, wherein:
the monomer (A) is a monomer of formula (1) wherein:
n is 1 or 2;
each R is independently selected from (C1-C4)alkyl; and
each R′ is independently selected from (C1-C4)alkyl; and
the monomer (B) is a monomer of formula (1) wherein:
n is 0; and
each R is independently selected from (C1-C4)alkyl.

17. The composition of claim 16, wherein the monomer (A) is selected from methyltrimethoxysilane, methyltriethoxysilane and dimethyldiethoxysilane, and the monomer (B) is tetraethoxysilane.

18. The composition of claim 15, wherein a molar ratio of the monomer (B) relative to the monomer (A) is from 0.01 to 0.5.

19. The composition of claim 18, wherein the molar ratio of the monomer (B) relative to the monomer (A) is from 0.1 to 0.3.

20. The composition of claim 14, wherein the condensation catalyst is selected from imidazoles, amidines and cyclic or bicyclic amidines.

21. The composition of claim 20, wherein the condensation catalyst is 1,8-diazabicyclo[5.4.0]undec-7-ene (DBU).

22. The composition of claim 14, wherein the first weak acid used for the hydrolysis of the at least two monomers of formula (1) is a carboxylic acid.

23. The composition of claim 22, wherein the carboxylic acid is an acetic acid, a propionic acid, a butyric acid, an acrylic acid or a mixture thereof.

24. The composition of claim 14, comprising a second acid.

25. The composition of claim 24, wherein the second acid is carboxylic acid.

26. The composition of claim 25, wherein the carboxylic acid is an acetic acid, a propionic acid, a butyric acid, an acrylic acid or a mixture thereof.

27. The composition of claim 14, having a pH between 3.5 and 5.0 inclusive.

28. The composition of claim 27, having a pH between 4.0 and 4.7 inclusive.

29. The composition of claim 14, the substrate being polymethyl methacrylate (PMMA).

30. A process for preparing a polymerizable composition of claim 14, comprising:
hydrolysing, in the presence of a first acid, at least two monomers of formula (1)
R′ₙSi(OR)₄₋ₙ (1)
wherein:
n is an integer between 0 and 3;
each R′ is independently selected from (C1-C6)alkyl, aryl, aryl(C1-C6)alkyl; and
each R is independently selected from (C1-C6)alkyl;
obtaining a hydrolyzate comprising a curable organosilicon compound and the first acid being a weak acid in an aqueous medium; and
adding a condensation catalyst and optionally a second weak acid to the hydrolyzate obtained in the hydrolysis step.

31. A lacquer obtained from the polymerizable composition of claim 14.

32. An ophthalmic lens comprising a substrate made of polyacrylate thermoplastic material coated with a lacquer obtained from the polymerizable composition of claim 14.

33. The ophthalmic lens of claim 32, wherein the substrate is made of PMMA.

34. A process for manufacturing an ophthalmic lens of claim 32, comprising:
applying the polymerizable composition of claim 14 to at least one face of a substrate made of polyacrylate thermoplastic material; and
thermally polymerizing the layer of polymerizable composition thus obtained.

35. The process of claim 34, wherein the substrate is made of PMMA.
